(19) United States
(12) Patent Application Publication
(10) Pub. No.: US 2024/0333067 A1
(43) Pub. Date: Oct. 3, 2024

(54) ROTATING ELECTRIC MACHINE SYSTEM

(71) Applicant: HONDA MOTOR CO., LTD., Tokyo (JP)

(72) Inventors: Manabu Yazaki, Wako-shi (JP); Tatsuya Choji, Wako-shi (JP)

(21) Appl. No.: 18/620,154

(22) Filed: Mar. 28, 2024

(30) Foreign Application Priority Data
Mar. 30, 2023 (JP) 2023-054540

(51) Int. Cl. H02K 3/50; H02K 1/16; H02K 3/38; H02K 9/193

(52) U.S. Cl. CPC H02K 3/50; H02K 1/16; H02K 3/38; H02K 9/193

(57) ABSTRACT

In a rotating electric machine system, a neutral point fixing structure includes a neutral point terminal disposed at a neutral point, an insulating member disposed between the neutral point terminal and a coil end portion, and a coolant passage in order to allow a liquid coolant to pass between the neutral point terminal and the insulating member. The neutral point terminal is fixed to the coil end portion via the insulating member.

### CROSS-REFERENCE TO RELATED APPLICATIONS

This application is based upon and claims the benefit of priority from Japanese Patent Application No. 2023-054540 filed on Mar. 30, 2023, the contents of which are incorporated herein by reference.

### BACKGROUND OF THE INVENTION

### Field of the Invention

The present invention relates to a rotating electric machine system.

### Description of the Related Art

In JP 2015-002647 A, it is disclosed that a neutral point is arranged at a coil end portion. According to this publication, the neutral point is cooled by dropping a liquid coolant onto the neutral point from a cooling mechanism. In JP 2019-176626 A, it is disclosed that a neutral point terminal is disposed at a coil end portion. According to this publication, the coil end portion and a neutral point terminal are cooled by discharging a liquid coolant toward the coil end portion and the neutral point terminal.

### SUMMARY OF THE INVENTION

In the aforementioned publications, since the neutral point (the neutral point terminal) is arranged at the coil end portion, the heat generated in the coils during operation of the rotating electric machine is transmitted from the coil end portion to the neutral point. Accordingly, it is desirable that the neutral point will not become high in temperature.

The present invention has the object of solving the aforementioned problem.

An aspect of the present invention is characterized by a rotating electric machine system equipped with a rotating electric machine including a rotor and a stator, and a housing in which the rotating electric machine is accommodated, wherein the housing accommodates the stator, and further includes a stator chamber through which a liquid coolant configured to cool the stator flows, and the stator includes a stator core, a coil unit including a plurality of coils formed by a plurality of wires that are wound around the stator core, and a coil end portion serving as end parts of the plurality of coils, and a neutral point fixing structure configured to fix to the coil end portion a neutral point formed by bundling together and connecting terminal ends of the plurality of conductive wires that are pulled out from the coil unit, wherein the neutral point fixing structure includes a neutral point terminal disposed at the neutral point, an insulating member disposed between the neutral point terminal and the coil end portion, and a coolant passage in order to allow the liquid coolant to pass between the neutral point terminal and the insulating member, and wherein the neutral point terminal is fixed to the coil end portion via the insulating member.

According to the present invention, the neutral point terminal is fixed to the coil end portion via the insulating member. Consequently, the coil end portion, which becomes of a high temperature at a time when the rotating electric machine is operating, and the neutral point terminal can be thermally separated. As a result, it is possible to prevent both the coils and the neutral point terminal from becoming high in temperature.

Further, the liquid coolant passes through the coolant passage provided between the neutral point terminal and the insulating member. In accordance with this feature, the neutral point terminal can be cooled, and conduction of heat from the coil end portion to the neutral point terminal can be reduced. As a result, a rise in temperature at the neutral point terminal can be suppressed.

Therefore, according to the present invention, it is possible to suppress a decrease in efficiency and deterioration of the rotating electric machine due to the generation of heat by the rotating electric machine.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a rotating electric machine system and a combined power system according to a present embodiment;

FIG. 2 is a cross-sectional view of the rotating electric machine system;

FIG. 3 is a partial cross-sectional view of the rotating electric machine system;

FIG. 4 is a partial cross-sectional view of the rotating electric machine system showing a flow direction of a cooling oil that flows through the interior of a stator chamber;

FIG. 5 is a system diagram in which there is schematically shown an example of a lubricating oil flow path in the rotating electric machine system;

FIG. 6 is a perspective view of a neutral point terminal and a pedestal;

FIG. 7 is a perspective view of the pedestal;

FIG. 8 is a cross-sectional view of an end part of coils, the pedestal, and the neutral point terminal; and

FIG. 9 is a cross-sectional view of the end part of the coils and the neutral point terminal according to an exemplary modification of the present embodiment.

### DETAILED DESCRIPTION OF THE INVENTION

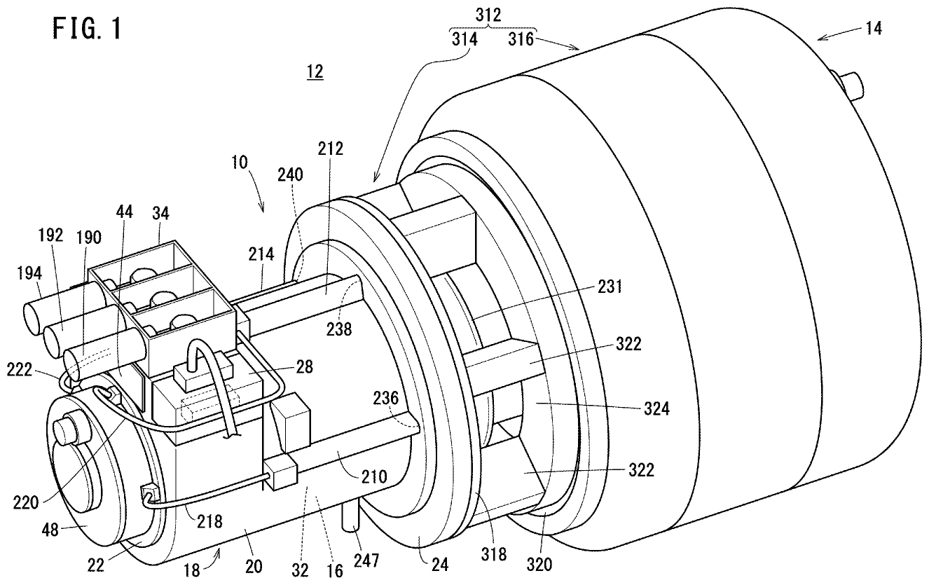

FIG. 1 is a perspective view of a rotating electric machine system 10 and a combined power system 12 according to a present embodiment.

The combined power system 12 is equipped with the rotating electric machine system 10, and a gas turbine engine 14. Each of the rotating electric machine system 10 and the gas turbine engine 14 extends along a longitudinal direction (axial direction). An axial line of the rotating electric machine system 10 and an axial line of the gas turbine engine 14 coincide with each other. Stated otherwise, the rotating electric machine system 10 and the gas turbine engine 14 are arranged in parallel on the same axis.

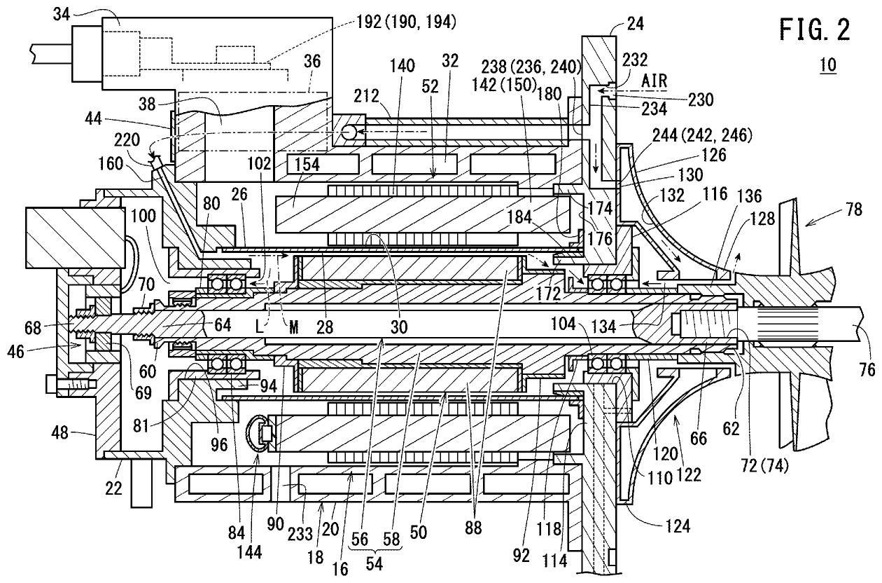

Hereinafter, the respective terms “left”, “right”, “lower”, and “upper” refer specifically to the left, right, lower and upper directions shown in FIG. 2 to FIG. 4. However, these directions are provided for the sake of convenience in order to simplify the description and to facilitate understanding. In particular, the directions described in the specification are not limited to the directions when the combined power system 12 is actually used.

Hereinafter, the left ends in the axial direction of each of the rotating electric machine system 10 and the gas turbine engine 14 may be referred to respectively as first ends. Similarly, the right ends in the axial direction of each of the rotating electric machine system 10 and the gas turbine engine 14 may be referred to respectfully as second ends.

More specifically, in the rotating electric machine system 10, the left end part which is separated away from the gas turbine engine 14 (refer to FIG. 1) is the first end. In the rotating electric machine system 10, the right end part which is in proximity to the gas turbine engine 14 is the second end. Further, in the gas turbine engine 14, the left end part which is in proximity to the rotating electric machine system 10 is the first end. In the gas turbine engine 14, the left end part which is separated away from the rotating electric machine system 10 is the second end. According to these definitions, in the illustrated example, the gas turbine engine 14 is disposed at the second end of the rotating electric machine system 10. The rotating electric machine system 10 is disposed at the first end of the gas turbine engine 14.

As shown in FIG. 1, the combined power system 12 is used, for example, as a power source for providing propulsion to a flying object, a ship, an automobile, or the like. Suitable specific examples of the flying object include drones and multi-copters. The combined power system 12, when mounted on a flying object, is used as a power drive source for rotationally urging, for example, a prop, a ducted fan, or the like. The combined power system 12, when mounted on a ship, is used as a screw rotational force generating device. The combined power system 12, when mounted on an automobile, is used as a power drive source for rotating a motor.

The combined power system 12 can also be used as an auxiliary power source in an aircraft, a ship, a building, or the like. Apart therefrom, it is also possible to utilize the combined power system 12 as gas turbine power generation equipment.

The gas turbine engine 14 is an internal combustion engine. Further, the gas turbine engine 14 serves as a gas supplying device that supplies compressed air (gas).

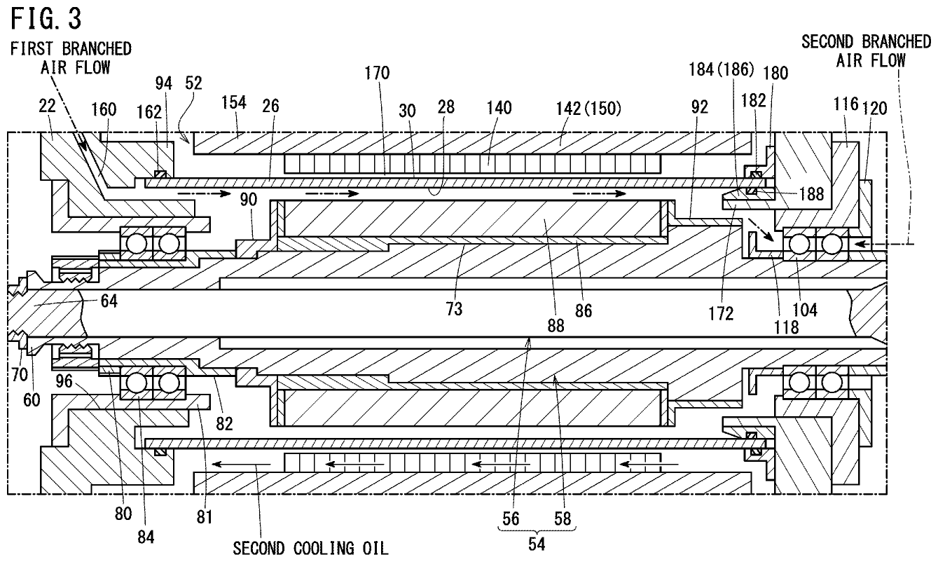

First, a description will be given concerning the rotating electric machine system 10. FIG. 2 is a cross-sectional view of the rotating electric machine system 10. FIG. 3 is an enlarged view of main components of the rotating electric machine system 10 (refer to FIG. 2). The rotating electric machine system 10 is equipped with a rotating electric machine 16 (for example, a generator), and a rotating electric machine housing 18 (housing) in which the rotating electric machine 16 is accommodated.

As shown in FIG. 1 and FIG. 2, the rotating electric machine housing 18 includes a main housing 20, a first sub-housing 22, and a second sub-housing 24. The main housing 20 has a substantially cylindrical shape. The first end and the second end of the main housing 20 are both open ends. The first sub-housing 22 is connected to the first end (the left open end) of the main housing 20. The second sub-housing 24 is connected to the second end (the right open end) of the main housing 20. In the manner described above, the first end and the second end of the main housing 20 are closed.

The main housing 20 includes thick-walled side walls. The side walls extend along the left-right direction. A hollow interior portion is formed in the main housing 20. Such a hollow interior portion is divided into a rotor chamber 28 and a stator chamber 30 by a partition wall member 26. The rotor chamber 28 is a chamber that is formed on an inner circumferential side (in the interior) of the partition wall member 26. The stator chamber 30 is a chamber that is formed on an outer circumferential side (externally) of the partition wall member 26.

A cooling jacket 32 is formed in the interior of a side wall of the main housing 20. A cooling medium (a coolant) such as cooling water or the like flows through the cooling jacket 32. The cooling jacket 32, for example, is a water jacket.

A first casing 34 and a second casing 36 are provided on an outer surface (outer wall) of the side wall of the main housing 20. The first casing 34 and the second casing 36 are provided in proximity to an edge part of the first end of the main housing 20. The first casing 34 and the second casing 36 serve as one portion of the main housing 20. More specifically, the first casing 34 and the second casing 36 are disposed integrally with the main housing 20. The first casing 34 is a terminal casing. The second casing 36 is a measurement instrument casing.

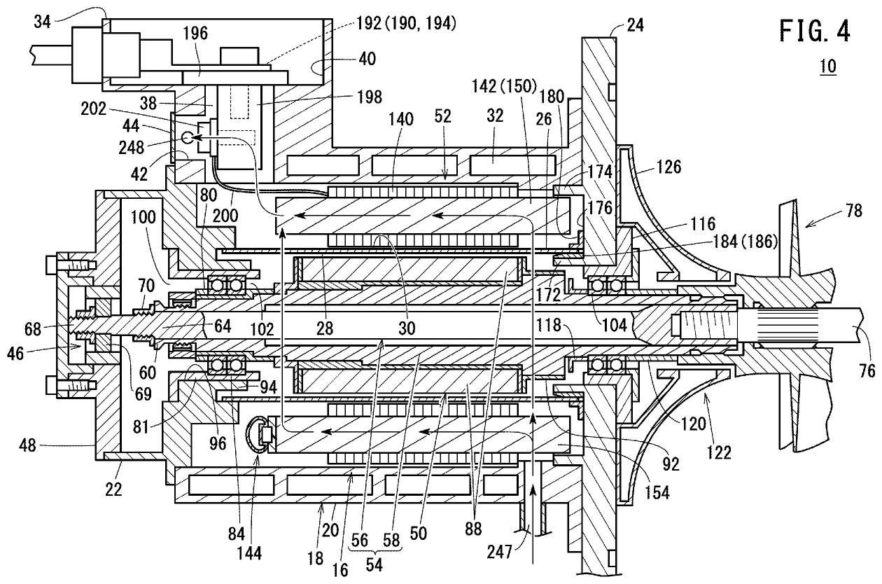

As shown in FIG. 4, a contact chamber 38 and a terminal chamber 40 are formed in the interior of the first casing 34. The contact chamber 38 is formed downwardly of the interior of the first casing 34. The terminal chamber 40 is formed upwardly of the interior of the first casing 34. The contact chamber 38 communicates with the stator chamber 30. An insertion port 42 is formed in the contact chamber 38. The insertion port 42 is open at an end surface facing toward the first end in the first casing 34. The insertion port 42 is closed by a lid member 44.

A retaining member is connected to the first sub-housing 22. The retaining member retains a rotational parameter detector. According to the present embodiment, as the rotational parameter detector, a resolver 46 is exemplified. Accordingly, hereinafter, the retaining member of the detector will be referred to as a “resolver holder 48”.

The rotating electric machine 16 includes a rotor 50 and a stator 52. The stator 52 surrounds the outer circumference of the rotor 50. The rotor 50 includes a rotating shaft 54. The partition wall member 26 is interposed between the rotor 50 and the stator 52 in a diametrical direction of the rotating shaft 54. Accordingly, the rotor 50 is positioned on the inner circumferential side of the partition wall member 26. Stated otherwise, the rotor 50 is accommodated in the rotor chamber 28. The stator 52 is positioned on the outer circumferential side of the partition wall member 26. Stated otherwise, the stator 52 is accommodated in the stator chamber 30.

The rotating shaft 54 includes an inner shaft 56, and a hollow tubular shaped outer shaft 58. Both ends of the outer shaft 58 are open ends. More specifically, as shown in FIG. 2, the outer shaft 58 has a left open end 60 and a right open end 62. The inner shaft 56 is removably inserted in the interior of the outer shaft 58.

The inner shaft 56 is longer in comparison with the outer shaft 58. The inner shaft 56 includes a left end part 64 and a right end part 66. The left end part 64 is an end (a first end) on the inner shaft 56 that is separated away from the gas turbine engine 14. The right end part 66 is an end (a second end) of the inner shaft 56 that is in close proximity to the gas turbine engine 14.

One portion of the left end part 64 is exposed from the left open end 60 of the outer shaft 58. The portion exposed from the left open end 60 is a projecting distal end 68. A resolver rotor 69 is attached to the left end part 64 of the inner shaft 56.

Further, an external threaded portion is formed at the left end part 64 of the inner shaft 56. A large cap nut 70 is screw-engaged with the externally threaded portion. A right end of the large cap nut 70 covers an outer circumferential wall of the left open end 60 of the outer shaft 58. In accordance with this feature, the left end part 64 of the inner shaft 56 is restrained by the left open end 60 of the outer shaft 58.

As shown in FIG. 2, the right end part 66 is the second end of the inner shaft 56. A connecting hole 72 is formed in the right end part 66. The left end part 64 is the first end of the inner shaft 56. The connecting hole 72 extends toward the left end part 64. A female threaded portion 74 is engraved on an inner circumferential wall of the connecting hole 72. The left end of an output shaft 76 is inserted into the connecting hole 72. The left end of the output shaft 76 is screw-engaged with the female threaded portion 74. Consequently, the left end of the output shaft 76 is coupled to the inner shaft 56. The output shaft 76 retains a compressor wheel 78 and a non-illustrated turbine wheel inside the gas turbine engine 14 (refer to FIG. 1).

As shown in FIG. 2 to FIG. 4, a first outer stopper 80 is provided on an outer circumferential wall of the left open end 60 of the outer shaft 58. The first outer stopper 80 is one of the bearing stoppers. A first inner stopper 82 is provided on an outer circumferential wall of the left open end 60 of the outer shaft 58. The first inner stopper 82 is another one of the bearing stoppers. A first bearing 84 is sandwiched between the first outer stopper 80 and the first inner stopper 82.

Permanent magnets 88 are held between the left open end 60 and the right open end 62 of the outer shaft 58 via a cylindrical member 86. The rotor 50 includes the rotating shaft 54, the cylindrical member 86, and the permanent magnets 88. An inner hole 73 is formed in the cylindrical member 86. The inner hole 73 extends along the axial direction of the cylindrical member 86. The rotating shaft 54 is passed through the inner hole 73. Accordingly, in the diametrical direction of the rotating shaft 54, the cylindrical member 86 is interposed between the rotating shaft 54 and the permanent magnets 88.

The cylindrical member 86 and the permanent magnets 88 are sandwiched between a first magnet stopper 90 and a second magnet stopper 92 in the axial direction of the rotating shaft 54. The first magnet stopper 90 and the second magnet stopper 92 cover the outer surface of the rotating shaft 54. Consequently, the cylindrical member 86 is positioned in the axial direction of the rotating shaft 54. More specifically, displacement of the cylindrical member 86 and the permanent magnets 88 in the axial direction of the rotating shaft 54 is prevented. In this manner, the first magnet stopper 90 and the second magnet stopper 92 serve to position the permanent magnets 88.

A left end (first end) of the rotating shaft 54 is rotatably supported by the first sub-housing 22 via the first bearing 84. The first bearing 84 is inserted between the outer shaft 58 and the first sub-housing 22. Specifically, the first sub-housing 22 has a columnar shaped projecting portion 94. The columnar shaped projecting portion 94 projects out toward the main housing 20. A first insertion hole 96 is formed in the columnar shaped projecting portion 94. A first bearing holder 81 is inserted into the first insertion hole 96. The first bearing holder 81 retains the first bearing 84. Accordingly, the first bearing 84 is arranged in the first insertion hole 96.

The first insertion hole 96 extends along the left-right direction. The left end of the first insertion hole 96 is separated farther away from the output shaft 76 than the right end of the first insertion hole 96 is. Hereinafter, the left end of the first insertion hole 96 may also be referred to as a “first distal end 100”. The right end of the first insertion hole 96 is closer to the output shaft 76 than the left end (the first distal end 100) of the first insertion hole 96 is. Hereinafter, the right end of the first insertion hole 96 may also be referred to as a “first proximal end 102”.

The distal end of the left end part of the rotating shaft 54 passes through the first insertion hole 96 after having passed through an inner hole of the first bearing 84. The distal end of the left end part of the rotating shaft 54 is further exposed on an outer side of the columnar shaped projecting portion 94.

A second bearing 104 is provided on the outer shaft 58. The second bearing 104 rotatably supports the right end (a second end) of the rotating shaft 54 on the second sub-housing 24. The second bearing 104 is inserted between the outer shaft 58 and the second sub-housing 24 which exhibits a substantially disk shape.

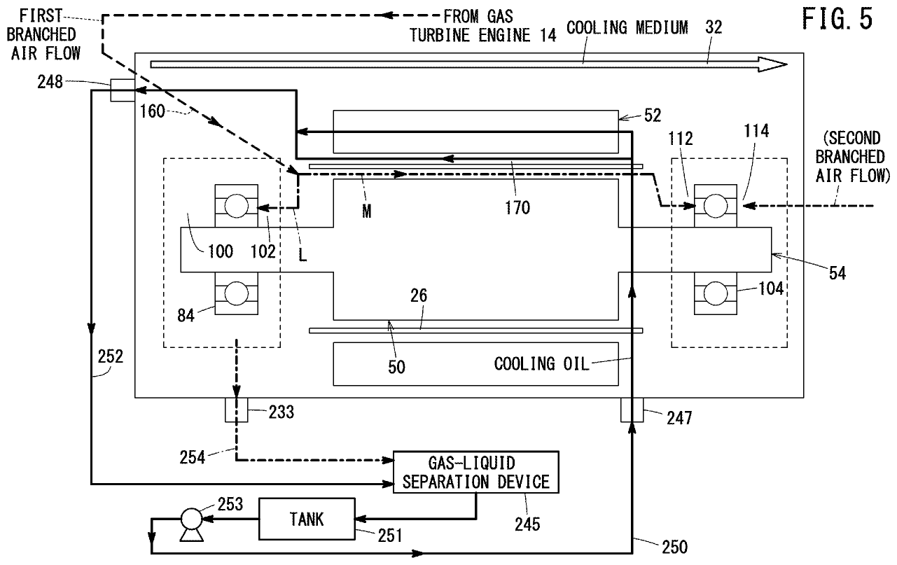

The second sub-housing 24 is connected to the main housing 20 via non-illustrated bolts. The center of the second sub-housing 24 is in the form of a thick-walled cylindrically shaped portion. A second insertion hole 110 is formed in such a cylindrically shaped portion. The second insertion hole 110 extends along the left-right direction. The left end of the second insertion hole 110 is separated farther away from the output shaft 76 than the right end of the second insertion hole 110 is. Hereinafter, the left end of the second insertion hole 110 may also be referred to as a “second distal end 112” (see FIG. 5). The right end of the second insertion hole 110 is closer to the output shaft 76 than the left end (the second distal end 112) of the second insertion hole 110 is. Hereinafter, the right end of the second insertion hole 110 may also be referred to as a “second proximal end 114”.

A second bearing holder 116 is inserted into the second insertion hole 110. The second bearing holder 116 retains the second bearing 104. Accordingly, the second bearing 104 is arranged in the second insertion hole 110. The second bearing 104 is sandwiched and held between a second inner stopper 118 and a second outer stopper 120. The second inner stopper 118 is positioned on the second distal end 112. The second outer stopper 120 is positioned on the second proximal end 114. Based on being sandwiched and held in this manner, the second bearing 104 is positioned and fixed in the axial direction of the rotating shaft 54. In this manner, the second inner stopper 118 and the second outer stopper 120 serve as bearing stoppers.

In the second sub-housing 24, a rectifying member 122 is connected to an end surface facing toward the gas turbine engine 14. The rectifying member 122 includes a base portion 124, a reduced-diameter portion 126, and a top portion 128. The base portion 124 which faces toward the second sub-housing 24 has a large diameter and a thin cylindrical plate shape. The top portion 128 which faces toward the gas turbine engine 14 has a small diameter and a relatively long cylindrical plate shape. In the reduced-diameter portion 126 between the base portion 124 and the top portion 128, the diameter thereof gradually becomes smaller. Accordingly, the rectifying member 122 is a chevron or mountain shaped body or a bottomless cup shaped body. The outer surface of the reduced-diameter portion 126 is a smooth surface with a small surface roughness.

In the base portion 124, inlet ports 130 are formed in an end surface thereof facing toward the second sub-housing 24. Further, the reduced-diameter portion 126 is hollow. More specifically, a relay chamber 132 is formed in the interior of the reduced-diameter portion 126. The inlet ports 130 serve as inlet ports for the compressed air to enter into the relay chamber 132.

An insertion hole 134 is formed in the top portion 128 along the left-right direction. A diameter (an opening diameter) of the insertion hole 134 is larger than the outer diameter of a portion in the second outer stopper 120 that extends along the rotating shaft 54. Therefore, a portion of the second outer stopper 120 that has entered into the insertion hole 134 and the outer circumferential wall is separated away from the inner wall of the insertion hole 134. The relay chamber 132 becomes wider as it comes closer in proximity to the insertion hole 134.

Further, a diameter (an opening diameter) of the insertion hole 134 is larger than the outer diameter of the relatively small left end (a small diameter cylindrical portion 136) of the compressor wheel 78. Therefore, the small diameter cylindrical portion 136 that has entered into the insertion hole 134 is also separated away from the inner wall of the insertion hole 134. Stated otherwise, a clearance is formed between the small diameter cylindrical portion 136 and the inner wall of the insertion hole 134.

The stator 52 constitutes the rotating electric machine 16 together with the aforementioned rotor 50. The stator 52 includes a stator core 140, a coil unit 142, and a neutral point fixing structure 144.

The stator core 140 is a cylindrical shaped member. The stator core 140 is constituted by laminating a plurality of ring-shaped electromagnetic steel plates in the axial direction. A plurality of slots are formed in the stator core 140. The plurality of slots are formed on an inner side of the stator core 140 at intervals in the circumferential direction. Teeth portions are formed between adjacent ones of the slots.

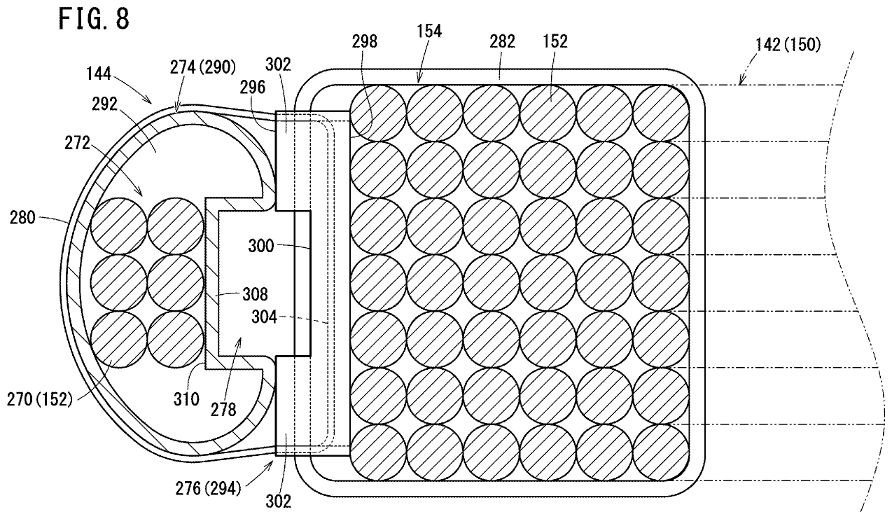

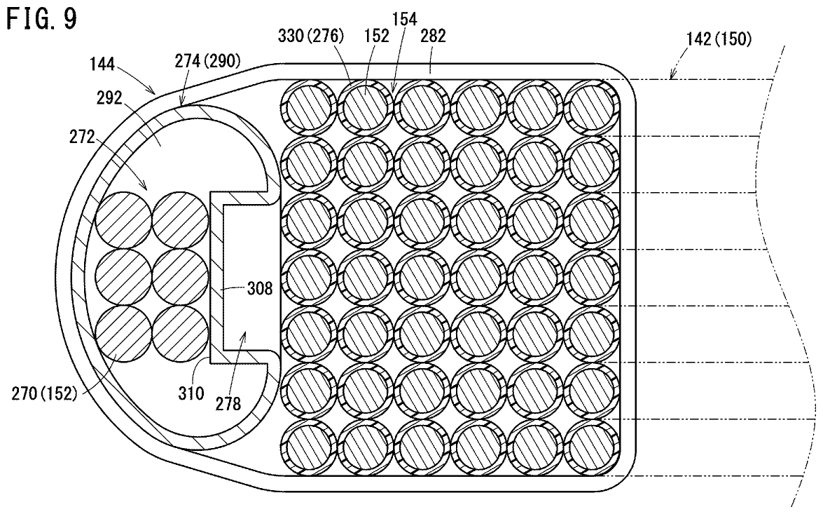

The coil unit 142 includes a plurality of electromagnetic coils 150 (coils). The plurality of electromagnetic coils 150 are U-phase coils, V-phase coils, and W-phase coils. Each of the plurality of electromagnetic coils 150 is constituted by winding a conductive wire 152 (refer to FIG. 8 and FIG. 9) around the teeth portions of the stator core 140. Therefore, the plurality of electromagnetic coils 150 are arranged in an annular shape with respect to the stator core 140.

Among the plurality of electromagnetic coils 150, portions thereof that protrude in the axial direction from the stator core 140 become end portions of the electromagnetic coils 150. The end portions of the plurality of electromagnetic coils 150 constitute a coil end portion 154. More specifically, the coil unit 142 includes the coil end portion 154 that serves as end parts of the plurality of electromagnetic coils 150.

Moreover, in the case that the rotating electric machine 16 is a generator, the rotating electric machine 16 is a so-called three-phase power source.

As noted previously, the partition wall member 26 is interposed between the rotor 50 and the stator 52. The partition wall member 26 is a cylindrically shaped body. Accordingly, the partition wall member 26 surrounds a major portion of the rotor 50 from the outer circumferential side. Consequently, the rotor chamber 28 is formed in the interior of the partition wall member 26. The rotor 50 is accommodated in the rotor chamber 28.

The compressed air, which is a gas, flows through the rotor chamber 28. The compressed air is delivered to the rotor chamber 28 in the first sub-housing 22. Therefore, three individual starting passages 160 are formed in the first sub-housing 22. In FIG. 2, an individual one from among the three individual starting passages 160 is shown.

As it proceeds from a first end toward a second end of the first sub-housing 22, the one individual starting passage 160 is inclined from an outer side in the diametrical direction toward an inner side in the diametrical direction of the first sub-housing 22. A first end of the starting passage 160 is open at an end surface of the first sub-housing 22 facing toward the first end thereof. Such an opening serves as an inlet for the compressed air into the interior of the rotating electric machine housing 18. A second end of the starting passage 160 opens toward a first end of the partition wall member 26. Such an opening serves as an inlet for the compressed air into the rotor chamber 28.

One portion of the compressed air flows from the starting passages 160 toward the first bearing 84. A remaining portion of the compressed air travels from the starting passages 160 via the rotor chamber 28, and flows toward the second bearing 104. In this manner, in the rotor chamber 28, the direction in which the compressed air flows is the first direction from the first end toward the second end.

As shown in FIG. 3, a distal end at a second end of the cylindrical columnar shaped projecting portion 94 enters between an inner hole of the stator 52 and the outer circumferential wall at the first end of the partition wall member 26. A first seal member 162 is provided at the distal end of the second end of the cylindrical columnar shaped projecting portion 94. The first seal member 162 is an O-ring. The first seal member 162 provides a seal between the distal end of the second end of the cylindrical columnar shaped projecting portion 94, and the outer circumferential wall at the first end of the partition wall member 26.

As shown in FIG. 2, a space is formed by the outer circumferential wall of the partition wall member 26 and the main housing 20. Such a space makes up the stator chamber 30. The stator 52 is accommodated in the stator chamber 30. The inner wall of the stator chamber 30 and the stator core 140 are slightly separated away from each other. More specifically, a clearance is formed between the inner wall of the stator chamber 30 and the stator core 140. Due to this clearance, the main housing 20 and the stator 52 are electrically insulated.

Cooling oil (a cooling medium or a coolant) flows through the stator chamber 30. The cooling oil is one portion of the lubricating oil that is supplied to the first bearing 84 and the second bearing 104. More specifically, the stator chamber 30 is one portion of a housing internal oil passage. The housing internal oil passage is formed in the interior of the rotating electric machine housing 18. In this instance, a clearance is also formed between the outer circumferential wall of the partition wall member 26 and the stator core 140. Such a clearance is also one portion of the oil passage. Hereinafter, such an oil passage will be referred to as a “stator inner circumferential side oil passage 170”. Moreover, the lubricating oil that flows through the stator chamber 30 (the housing internal oil passage) and the stator inner circumferential side oil passage 170 is a divided flow that is divided from the lubricating oil supplied to the first bearing 84 and the second bearing 104.

In the second sub-housing 24, an inner annular shaped projecting member 172 and an outer annular shaped projecting member 174 are provided on a surface thereof facing toward the first end. The inner annular shaped projecting member 172 and the outer annular shaped projecting member 174 are provided concentrically. The inner annular shaped projecting member 172 is positioned on the inner circumference of the outer annular shaped projecting member 174. An annular shaped concave portion 176 is formed between the inner annular shaped projecting member 172 and the outer annular shaped projecting member 174. The coil unit 142 is inserted into the annular shaped concave portion 176.

The inner annular shaped projecting member 172 is passed through a through hole of an annular shaped holder 180. A second end of the annular shaped holder 180 has an enlarged diameter in the form of a flange. A second end of the annular shaped holder 180 is placed in contact with an end surface of the first end of the annular shaped concave portion 176.

A first end of the annular shaped holder 180 extends toward the partition wall member 26. At the first end of the annular shaped holder 180, a second seal member 182 is provided on an inner surface facing toward the outer circumferential wall of the partition wall member 26. The second seal member 182 is an O-ring. The second seal member 182 provides a seal between the inner circumferential wall at the first end of the annular shaped holder 180, and the outer circumferential wall at the second end of the partition wall member 26.

An annular shaped guide 184 is interposed between the inner annular shaped projecting member 172 and the inner circumferential wall at the second end of the partition wall member 26. A first end of the annular shaped guide 184 is a tapered portion 186 that reduces in diameter in a tapered shape as it progresses toward a first end. In the annular shaped guide 184, a third seal member 188 is provided on an outer surface thereof facing toward the inner circumferential wall of the partition wall member 26. The third seal member 188 is an O-ring. The third seal member 188 provides a seal between an outer circumferential wall of the annular shaped guide 184, and the inner circumferential wall at the second end of the partition wall member 26.

Due to the presence of the first seal member 162, the second seal member 182, and the third seal member 188, the rotor chamber 28 and the stator chamber 30 become spaces that are independent from each other. In accordance with this feature, for example, the compressed air supplied to the rotor chamber 28 is prevented from leaking into the stator chamber 30. Further, the lubricating oil supplied to the stator chamber 30 is prevented from leaking into the rotor chamber 28.

The outer circumferential wall at the first end of the partition wall member 26 contacts the first sub-housing 22 via the first seal member 162. The second end of the partition wall member 26 is sandwiched between the annular shaped guide 184 and the annular shaped holder 180 via the second seal member 182 and the third seal member 188.

In the case that the wall thickness of the partition wall member 26 is large, the weight of the partition wall member 26 becomes large. Further, in the case that the wall thickness of the partition wall member 26 is large, the rotating electric machine 16 becomes large along the diametrical direction. Furthermore, the partition wall member 26 having such a large wall thickness interrupts the alternating magnetic field between the permanent magnets 88 and the electromagnetic coils 150. In order to avoid such an inconvenience, it is preferable for the wall thickness to be as small as possible. The wall thickness, for example, is preferably around 1 mm.

Accordingly, even though it is thin-walled, the partition wall member 26 should preferably be made of a material having sufficient strength and rigidity. As a suitable example of such a material, there may be cited ceramics. Insulating and non-magnetic ceramics are particularly suitable. In accordance therewith, it is possible to avoid interrupting the alternating magnetic field between the rotor 50 and the stator 52. As detailed examples of such insulating and non-magnetic ceramics, there may be cited aluminum nitride (AlN), silicon nitride (Si₃N₄), and alumina (Al₂O₃). Among these ceramics, alumina is particularly preferred because it is inexpensive.

As noted previously, the first casing 34 and the second casing 36 are integrally provided on a side wall in proximity to the left end of the main housing 20. As shown in FIG. 4, a U-phase terminal 190, a V-phase terminal 192, and a W-phase terminal 194 are accommodated in the terminal chamber 40 of the first casing 34. The U-phase terminal 190 is electrically connected to a plurality of U-phase coils within the plurality of electromagnetic coils 150. The V-phase terminal 192 is electrically connected to a plurality of V-phase coils within the plurality of electromagnetic coils 150. The W-phase terminal 194 is electrically connected to a plurality of W-phase coils within the plurality of electromagnetic coils 150. The U-phase terminal 190, the V-phase terminal 192, and the W-phase terminal 194 are electric terminal portions to which an external device (an external load or an external power source) is electrically connected. Electrical power generated by the rotating electric machine 16 is supplied to the external device. As the external load, for example, there may be cited a non-illustrated motor. As another external device, for example, there may be cited a battery.

An electrical contact between the U-phase terminal 190 and the plurality of U-phase coils is provided in the contact chamber 38 of the first casing 34. An electrical contact between the V-phase terminal 192 and the plurality of V-phase coils is similarly provided in the contact chamber 38. An electrical contact between the W-phase terminal 194 and the plurality of W-phase coils is similarly provided in the contact chamber 38. When describing the electrical contact between the V-phase terminal 192 and the plurality of V-phase coils, the V-phase terminal 192 includes a blocking convex portion 196. The blocking convex portion 196 closes and blocks a communication opening between the contact chamber 38 and the terminal chamber 40. Due to being blocked in this manner, the contact chamber 38 and the terminal chamber 40 become spaces that are independent from each other.

A terminal portion 198 of the V-phase terminal 192 is provided on the blocking convex portion 196. The terminal portion 198 extends into the contact chamber 38. Further, a terminal wire 200 is one end part (a distal end) of each of the conductive wires 152 that are drawn out from end parts of the V-phase coils. The terminal wires 200 are routed into the contact chamber 38. Inside the contact chamber 38, the terminal portion 198 and the terminal wires 200 are connected via screws 202. In accordance with this feature, the V-phase terminal 192 and the plurality of V-phase coils are electrically connected. Although not shown in particular, the U-phase terminal 190 and the plurality of U-phase coils are similarly connected inside the contact chamber 38. In the same manner, the W-phase terminal 194 and the plurality of W-phase coils are connected inside the contact chamber 38.

A first hollow tube portion 210, a second hollow tube portion 212, and a third hollow tube portion 214 are provided on an outer circumferential wall of the main housing 20. The hollow interior portions of the first hollow tube portion 210, the second hollow tube portion 212, and the third hollow tube portion 214 are compressed air flow paths through which the compressed air flows. More specifically, according to the present embodiment, three individual compressed air flow paths are formed in the rotating electric machine housing 18. The first hollow tube portion 210 and the third hollow tube portion 214 are formed as hollow bulging portions that bulge out from the outer circumferential wall of the main housing 20.

As shown in FIG. 2, in the first sub-housing 22, on an end surface facing toward the first end, distal ends of the three individual starting passages 160 are open respectively at the first end. As shown in FIGS. 1 and 2, an individual one of the openings from among the three individual starting passages 160 is connected via a flexible tube 218 to the first hollow tube portion 210. Another individual one of the openings from among the three individual starting passages 160 is connected via a flexible tube 220 to the second hollow tube portion 212. Another individual one of the openings from among the three individual starting passages 160 is connected via a flexible tube 222 to the third hollow tube portion 214.

A compressed air flow path and a lubricating oil flow path are provided in the rotating electric machine system 10 which is constituted in the manner described above. First, a description will be given concerning the compressed air flow path.

In the second sub-housing 24, on an end surface thereof facing toward the gas turbine engine 14, an annular shaped collection flow path 230 is formed therein as an annular concave portion. As will be discussed later, a portion of the compressed air generated by the gas turbine engine 14 flows through the collection flow path 230. Three individual upstream communication holes 232 are formed in a bottom wall of the collection flow path 230 (the annular concave portion). The upstream communication holes 232 serve as input ports for the compressed air.

Air relay passages 234 are provided as gas branching passages in the interior of the second sub-housing 24. The air relay passages 234 extend radially along a diametrical direction of the second sub-housing 24. The air relay passages 234 communicate on an outer side in the diametrical direction with the collection flow path 230 via the upstream communication holes 232. Further, in the second sub-housing 24, three individual first downstream communication holes 236, 238, and 240 are formed in an end surface facing toward the rotating electric machine 16. The first downstream communication holes 236, 238, and 240 serve as first output ports of the air relay passages 234. A distribution passage is formed by the collection flow path 230 and the air relay passages 234.

In the second sub-housing 24, three individual second downstream communication holes 242, 244, and 246 are formed in an end surface facing toward the gas turbine engine 14. The second downstream communication holes 242, 244, and 246 serve as second output ports of the air relay passages 234. The second downstream communication holes 242, 244, and 246 are positioned more radially inward in a diametrical direction than the first downstream communication holes 236, 238, and 240. Accordingly, the compressed air that has flowed through the air relay passages 234 is divided into two portions of compressed air. One of the compressed air portions (a first partial air flow) enters into the first downstream communication holes 236, 238, and 240. Another of the compressed air portions (a second partial air flow) enters into the second downstream communication holes 242, 244, and 246. In this manner, the air relay passages 234 fulfill a roll as branching passages.

As shown in FIG. 1, the first hollow tube portion 210, the second hollow tube portion 212, and the third hollow tube portion 214 are provided on the outer surface of the side wall of the main housing 20. The first downstream communication holes 236, 238, and 240, respectively, open individually toward the first hollow tube portion 210 to the third hollow tube portion 214. As can be understood from this feature, the air relay passages 234 place the collection flow path 230 in communication with the hollow interiors of the first hollow tube portion 210 to the third hollow tube portion 214. As shown in FIG. 2, the cooling jacket 32 is formed on a side wall inner portion of the main housing 20. The first hollow tube portion 210 to the third hollow tube portion 214 are positioned diametrically outward of the cooling jacket 32.

The first hollow tube portion 210 to the third hollow tube portion 214 extend along the axial direction of the main housing 20. More specifically, the first hollow tube portion 210 to the third hollow tube portion 214 extend from the second end that faces toward the gas turbine engine 14, and toward the first casing 34 (or the first end). As noted previously, the first hollow tube portion 210 to the third hollow tube portion 214 are connected respectively to the three starting passages 160 via the flexible tubes 218, 220, and 222. Accordingly, the compressed air that has flowed through the first hollow tube portion 210 to the third hollow tube portion 214 flows into the starting passages 160 via the flexible tubes 218, 220, and 222. As can be understood from this feature, the first hollow tube portion 210 to the third hollow tube portion 214 are gas supply passages for supplying the compressed air.

According to the present embodiment, a case is illustrated in which the first hollow tube portion 210 to the third hollow tube portion 214 are provided. The number of the hollow tube portions is appropriately determined in accordance with the flow rate or the flow velocity required for the curtain air that is formed from the compressed air. More specifically, the number of the hollow tube portions is not limited to being three. Further, in a similar manner, the cross-sectional area of the hollow tube portions is appropriately determined in accordance with the flow rate or the flow velocity required for the curtain air.

The compressed air that has flowed into the starting passages 160 is thereafter divided into compressed air that is directed toward the first insertion hole 96, and compressed air that is directed toward the second insertion hole 110. Specifically, one portion of the compressed air flows through a clearance between the first sub-housing 22 and the rotor 50. The one portion of the compressed air flows through the clearance and toward the first insertion hole 96. In this manner, the clearance between the first sub-housing 22 and the rotor 50 forms a first air branching passage L. On the other hand, a remaining portion of the compressed air primarily flows through a clearance between the outer wall of the permanent magnets 88 and an inner wall of the partition wall member 26. The one portion of the compressed air flows through the clearance and toward the second insertion hole 110. In this manner, the clearance between the outer walls of the permanent magnets 88 and the inner wall of the partition wall member 26 forms a second air branching passage M.

The compressed air that has reached the first air branching passage L forms an air curtain. Such an air curtain seals the lubricating oil that is supplied to the first bearing 84. Further, the compressed air that has reached the second distal end 112 of the second insertion hole 110 from the second air branching passage M forms an air curtain. Such an air curtain seals the lubricating oil that is supplied to the second bearing 104. In this manner, the compressed air that has flowed through the starting passages 160 functions as a curtain air.

Three individual inlet ports 130 are formed in the base portion 124 of the rectifying member 122. An individual one from among the inlet ports is shown in FIG. 2. An individual one of the inlet ports 130 extends to the second downstream communication hole 242. Another individual one of the inlet ports 130 extends to the second downstream communication hole 244. Further, the other individual one of the inlet ports 130 extends to the second downstream communication hole 246. Accordingly, the compressed air output from the second downstream communication holes 242, 244, and 246 enters into the relay chamber 132 of the reduced-diameter portion 126 of the rectifying member 122 via the inlet ports 130.

The relay chamber 132 extends to the insertion hole 134 that is formed in the top portion 128. In this instance, the relay chamber 132 becomes wider as it comes closer in proximity to the insertion hole 134. Therefore, as the compressed air flows through the relay chamber 132, the pressure of the curtain air decreases.

The outlet of the relay chamber 132 faces toward the small diameter cylindrical portion 136 of the compressor wheel 78. Accordingly, the compressed air that has entered into the relay chamber 132 comes into contact with the small diameter cylindrical portion 136 of the compressor wheel 78. Thereafter, the compressed air is divided into compressed air that is directed toward the second bearing 104, and compressed air that is directed toward the outlet passage (not shown). As a result, the pressure of the compressed air toward the second proximal end 114 of the second insertion hole 110 is reduced.

The compressed air that has reached the second proximal end 114 of the second insertion hole 110 forms an air curtain. Such an air curtain seals the lubricating oil that is supplied to the second bearing 104. Further, the compressed air that has flowed into the outlet passage is discharged in an inward direction from a first end (an open end) in a shroud case 231 (refer to FIG. 1). The compressed air is drawn back again into the compressor wheel 78.

As shown in FIG. 2, an exhaust passage 233 (a gas exhaust passage) is formed in the main housing 20. The compressed air that has reached the first air branching passage L and the compressed air that has reached the second air branching passage M pass through the exhaust passage 233 and are discharged to the exterior of the main housing 20.

Next, a description will be given concerning the lubricating oil flow path. FIG. 4 is a cross-sectional view of the rotating electric machine system 10. Moreover, in FIG. 4, a phase is shown that differs from the phase shown in FIG. 2. FIG. 5 is a system diagram in which there is schematically shown an example of a lubricating oil flow path in the rotating electric machine system 10.

The rotating electric machine housing 18 includes an input tube portion 247 serving as an oil supply passage, and an output tube portion 248 serving as an oil recovery passage. The input tube portion 247 is provided in proximity to the second end of the main housing 20. The output tube portion 248 is provided on a side portion of the first casing 34. The input tube portion 247 and the output tube portion 248 are, respectively, hollow portions having internal passages therein. An internal passage of the input tube portion 247 communicates with the stator chamber 30. The internal passage of the output tube portion 248 communicates with the contact chamber 38 of the first casing 34.

The lubricating oil flow path is formed in the rotating electric machine housing 18. The lubricating oil flow path includes an oil supply path (an oil supply line) and an oil recovery path (an oil recovery line). The rotating electric machine housing 18 includes a gas-liquid separation device 245, a tank 251, and a circulation pump 253.

The gas-liquid separation device 245 includes an oil supply line 250, an oil recovery line 252, and an exhaust line 254. The oil supply line 250 connects the gas-liquid separation device 245 and the input tube portion 247. The tank 251 and the circulation pump 253 are provided in the middle of the oil supply line 250. The oil recovery line 252 connects the output tube portion 248 and the gas-liquid separation device 245. The exhaust line 254 connects the exhaust passage 233 and the gas-liquid separation device 245.

The gas-liquid separation device 245 recovers the compressed air and the lubricating oil that have flowed through the interior of the rotating electric machine housing 18. The gas-liquid separation device 245 supplies the recovered lubricating oil again to the interior of the rotating electric machine housing 18. In this manner, the gas-liquid separation device 245 constitutes an oil circulation supply device.

The lubricating oil that flows into the gas-liquid separation device 245 is a gas-liquid mixture. In the gas-liquid separation device 245, the gas-liquid mixture is separated into the lubricating oil and air. The lubricating oil is temporarily stored in the tank 251. Thereafter, the lubricating oil is drawn in from the tank 251 by the circulation pump 253. The drawn-in lubricating oil is supplied again to the input tube portion 247 via the oil supply line 250. On the other hand, the air is released into the atmosphere.

Accordingly, the lubricating oil that is stored in the tank 251 is supplied to the stator chamber 30 via the oil supply line 250 and the input tube portion 247. In the stator chamber 30, the lubricating oil flows, for example, through the stator inner circumferential side oil passage 170. The lubricating oil may also pass through slots in the stator 52, or alternatively, through gaps or the like between the electromagnetic coils 150.

In the stator chamber 30, the direction in which the compressed air flows is the second direction from the second end toward the first end. Consequently, the lubricating oil sufficiently flows through both the first end and the second end of the electromagnetic coils 150. As noted previously, the stator chamber 30 communicates with the contact chamber 38 of the first casing 34. Accordingly, the lubricating oil flows into the contact chamber 38 of the first casing 34. In this instance, the oil recovery line 252 is connected to the output tube portion 248. Accordingly, the lubricating oil inside the contact chamber 38 is recovered in the gas-liquid separation device 245 via the output tube portion 248 and the oil recovery line 252.

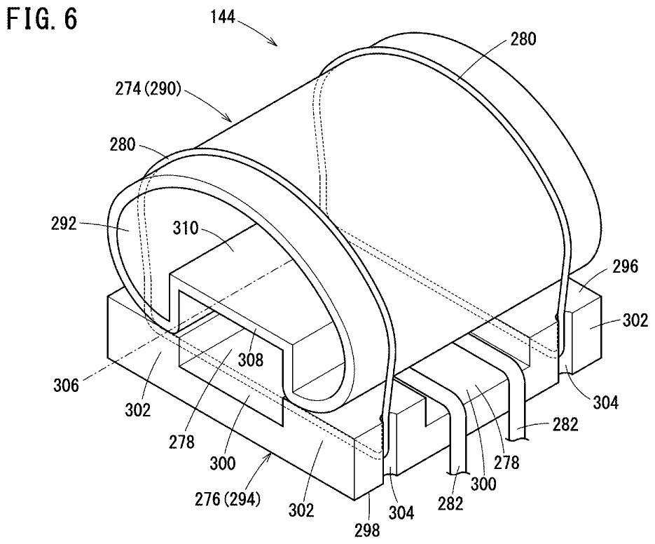

Next, with reference to FIG. 6 to FIG. 9, a description will be given concerning the neutral point fixing structure 144.

Concerning each of the plurality of electromagnetic coils 150, other ends (terminal ends 270) of the conductive wires 152 that make up the electromagnetic coils 150 are pulled out from the coil end portion 154 of the coil unit 142. The terminal ends 270 of the plurality of conductive wires 152, by being bundled together and connected, thereby constitute a neutral point 272. The neutral point fixing structure 144 fixes the neutral point 272 to the coil end portion 154.

The neutral point fixing structure 144 includes a neutral point terminal 274, an insulating member 276, a coolant passage 278, a first threaded member 280, and a second threaded member 282.

The neutral point terminal 274 is disposed at the neutral point 272. The insulating member 276 is disposed between the neutral point terminal 274 and the coil end portion 154. The neutral point terminal 274 is fixed to the coil end portion 154 via the insulating member 276. The coolant passage 278 allows the lubricating oil, which is a liquid coolant, to pass between the neutral point terminal 274 and the insulating member 276.

Specifically, the neutral point terminal 274 is a tubular shaped member 290. The tubular shaped member 290, for example, is a conductive tubular shaped member. The tubular shaped member 290 may also be a non-conductive tubular shaped member. The terminal ends 270 of the plurality of conductive wires 152 that are drawn out from the coil unit 142 are inserted into an inner side space 292 of the tubular shaped member 290.

The insulating member 276 is a pedestal 294 that is disposed on the coil end portion 154 and on which the neutral point terminal 274 is arranged. The pedestal 294 is a rectangular shaped block. The pedestal 294 is made of an electrically insulating material such as PTFE or the like.

The pedestal 294 includes a first surface 296 and a second surface 298 which are surfaces that are opposite to each other. The neutral point terminal 274 is arranged on the first surface 296. The second surface 298 abuts against the coil end portion 154.

On the first surface 296, first concave portions 300 are formed along the first surface 296. Specifically, on the first surface 296, two of the first concave portions 300 are formed along the first surface 296. The two first concave portions 300 intersect one another. According to the present embodiment, the first surface 296 of the pedestal 294 is recessed in a cross shape toward the second surface 298. In accordance with this feature, the two first concave portions 300 that are perpendicular to each other are formed in the first surface 296. Accordingly, by the two first concave portions 300 being formed in this manner, rectangular shaped projecting members 302 are formed at the four corners of the pedestal 294. The four projecting members 302 project out in a manner so as to separate away from the coil end portion 154. The neutral point terminal 274 is arranged on the four projecting members 302.

Locking grooves 304 are formed in the pedestal 294. The locking grooves 304 are formed in portions within the surface of the pedestal 294 that do not come into contact with the neutral point terminal 274. According to the present embodiment, two of the locking grooves 304 are formed in the pedestal 294. The two of the locking grooves 304 are formed in the pedestal 294 with a space between them. Each of the two locking grooves 304 is formed in a U-shape between a side surface of one of the projecting members 302, the second surface 298, and a side surface of the other one of the projecting members 302.

The tubular shaped member 290, which is the neutral point terminal 274, for example, is a conductive member. The tubular shaped member 290 may also be a non-conductive member. The outer circumferential surface of the tubular shaped member 290 abuts against the first surface 296 of the pedestal 294. The tubular shaped member 290 abuts against the first surface 296, in a manner so that a central axial line 306 is parallel to the first surface 296. The tubular shaped member 290 is arranged on the pedestal 294 with the outer circumferential surface abutting against the first surface 296. Moreover, from among the two of the first concave portions 300 that are formed in the first surface 296, the central axial line 306 of the tubular shaped member 290 is preferably in parallel with the direction in which one of the first concave portions 300 extends.

The terminal ends 270 of the plurality of conductive wires 152 are inserted into the inner side space 292 of the tubular shaped member 290. The terminal ends 270 of the plurality of conductive wires 152 are drawn out from the coil unit 142.

Within the tubular shaped member 290, a portion thereof that faces toward one of the first concave portions 300 is recessed on an inner side of the tubular shaped member 290, thereby forming a second concave portion 308. Specifically, the second concave portion 308 is formed in a portion within an outer circumferential surface of the tubular shaped member 290 that abuts against the first surface 296 of the pedestal 294. The second concave portion 308 is formed along the central axial line 306 of the tubular shaped member 290. Two of the first concave portions 300 are formed on the pedestal 294. Therefore, from among the two first concave portions 300, the second concave portion 308 is formed in parallel with one of the first concave portions 300.

By the second concave portion 308 being recessed on the inner side of the tubular shaped member 290, a projecting member 310 that projects toward the inside of the tubular shaped member 290 is formed in the inner side space 292 of the tubular shaped member 290. The projecting member 310 presses the terminal ends 270 of the plurality of conductive wires 152 that are inserted into the inner side space 292 of the tubular shaped member 290. In accordance with this feature, the terminal ends 270 of the plurality of conductive wires 152 are fixed in the inner side space 292 of the tubular shaped member 290.

The coolant passage 278 is constituted by the first concave portions 300 and the second concave portion 308. As described above, two of the first concave portions 300 are formed in the pedestal 294. Further, the second concave portion 308 is formed in the tubular shaped member 290. Therefore, by the tubular shaped member 290 being disposed on the first surface 296 (the four projecting members 302) of the pedestal 294, one coolant passage 278 is constituted by one of the first concave portions 300 and the second concave portion 308. Further, another coolant passage 278 is constituted by another one of the first concave portions 300. Stated otherwise, two of the coolant passages 278 are formed between the tubular shaped member 290 and the pedestal 294.

The first threaded member 280 is wound around the pedestal 294, and also around the neutral point terminal 274 (the tubular shaped member 290) that is arranged on the pedestal 294. Specifically, two of the first threaded members 280 are wound around the pedestal 294 and the neutral point terminal 274. Two locking grooves 304 are formed in the pedestal 294. One of the first threaded members 280 is wound around the pedestal 294 and the neutral point terminal 274, in a manner so as to be locked in one of the locking grooves 304. Another one of the first threaded members 280 is wound around the pedestal 294 and the neutral point terminal 274, in a manner so as to be locked in the other one of the locking grooves 304. Consequently, the neutral point terminal 274 is fixed to the pedestal 294.

The second threaded member 282 is wound around the coil end portion 154, and also around the pedestal 294 that is disposed on the coil end portion 154. Specifically, two of the second threaded members 282 are wound around the coil end portion 154 and the pedestal 294. The two second threaded members 282 are wound around the coil end portion 154 and the pedestal 294, in a manner so as to be locked in the other of the first concave portions 300. Consequently, the pedestal 294 is fixed to the coil end portion 154.

Next, with reference to FIG. 1 and FIG. 2, a description will be given concerning the configuration of the gas turbine engine 14.

The gas turbine engine 14 comprises an engine housing 312, and the output shaft 76 that rotates inside the engine housing 312. The engine housing 312 includes an inner housing 314 and an outer housing 316. The inner housing 314 is connected to the second sub-housing 24 of the rotating electric machine system 10. The outer housing 316 is connected to the inner housing 314. The outer housing 316 forms a housing main body.

The inner housing 314 includes a first annular portion 318, a second annular portion 320, and a plurality of individual leg members 322. The first annular portion 318 is connected to the second sub-housing 24. The diameter of the second annular portion 320 is greater than the diameter of the first annular portion 318. The leg members 322 connect the first annular portion 318 and the second annular portion 320. In the illustrated example, the number of the leg members 322 is six. However, the number of the leg members 322 is determined in accordance with the necessary coupling strength required between the gas turbine engine 14 and the rotating electric machine system 10. Stated otherwise, the number of the leg members 322 is not limited to being six as in the illustrated example.

A cylindrically shaped cover member 324 projects out toward the rotating electric machine system 10 from a central opening of the second annular portion 320. Right ends of the leg members 322 continue to the cylindrically shaped cover member 324. An air intake space is formed between the leg members 322.

The compressor wheel 78 and a non-illustrated turbine wheel are capable of rotating integrally together with the rotating shaft 54 and the output shaft 76.

The rotating electric machine system 10 and the combined power system 12 according to the present embodiment are basically configured in the manner described above. Next, a description will be given concerning the advantageous effects of the rotating electric machine system 10 and the combined power system 12.

First, an AC current is supplied to the plurality of electromagnetic coils 150 (the U-phase coils, the V-phase coils, and the W-phase coils) via the U-phase terminal 190, the V-phase terminal 192, and the W-phase terminal 194. By the AC current flowing through the electromagnetic coils 150, an alternating magnetic field is generated in the stator 52. Therefore, an attractive force and a repulsive force act alternately between the electromagnetic coils 150 and the permanent magnets 88 of the rotor 50. As a result, the rotating shaft 54 begins to rotate. Alternatively, the rotating shaft 54 may be rotated by a well-known type of starter (not shown).

A rotational torque of the rotating shaft 54 is transmitted to the output shaft 76 via the compressor wheel 78. More specifically, when the rotating shaft 54 begins to rotate, the output shaft 76 also starts rotating integrally together with the rotating shaft 54. Along therewith, the compressor wheel 78 and the non-illustrated turbine wheel, which are supported on the output shaft 76, rotate integrally together with the output shaft 76.

Due to the above-described rotation, atmospheric air is drawn into the shroud case 231 through an air intake space formed between the leg members 322 of the inner housing 314. In this instance, the rectifying member 122 is positioned at the diametrical center of the inner housing 314. As noted previously, the rectifying member 122 exhibits a chevron or mountain shape that becomes smaller in diameter toward the shroud case 231. In addition, the surface of the reduced diameter portion 126 is smooth. Therefore, the atmospheric air that is drawn in is rectified by the rectifying member 122 in a manner so as to flow toward the shroud case 231. Further, a right end of the rectifying member 122 enters from a left end opening of the shroud case 231. In accordance with this feature, the atmosphere is efficiently guided into the shroud case 231.

The atmospheric air that is drawn into the shroud case 231 flows between the compressor wheel 78 and the shroud case 231. In comparison with the left opening of the shroud case 231, the space between the compressor wheel 78 and the shroud case 231 is sufficiently narrow. In accordance with this feature, when flowing therethrough in this manner, the atmospheric air is compressed. Stated otherwise, the compressed air is generated. One portion of the compressed air flows into a chamber of the gas turbine engine 14 and is temporarily stored therein.

Further, one portion of the compressed air flows into the collection flow path 230 and is collected therein as curtain air. The one portion of the compressed air that is collected is diffused in an annular shape along the collection flow path 230. The curtain air flows individually into the three upstream communication holes 232 from the collection flow path 230. The three curtain airs that have flowed in this manner are individually distributed along the three individual air relay passages 234. Thereafter, one portion of the curtain air is discharged from the first downstream communication holes 236, 238, and 240. Further, a remaining portion of the curtain air is discharged from the second downstream communication holes 242, 244, and 246. Hereinafter, the curtain air that is discharged from the “first downstream communication holes 236, 238, and 240 will be referred to as a “first branched air flow”. The curtain air that is discharged from the second downstream communication holes 242, 244, and 246 will be referred to as a “second branched air flow”.

A description will now be given concerning the route of the first branched air flow. The first downstream communication hole 236 communicates with the hollow interior of the first hollow tube portion 210. The first downstream communication hole 238 communicates with the hollow interior of the second hollow tube portion 212. The first downstream communication hole 240 communicates with the hollow interior of the third hollow tube portion 214. Accordingly, the first branched air flow flows through the hollow interior portions of the first hollow tube portion 210 to the third hollow tube portion 214 shown in FIG. 1 and the like. The first branched air flow that has flowed therethrough in this manner flows from the second end toward the first end of the rotating electric machine housing 18. More specifically, prior to the first branched air flow entering into the rotor chamber 28 inside the rotating electric machine housing 18, the direction in which the first branched air flow flows is the second direction.

The first hollow tube portion 210 to the third hollow tube portion 214 are positioned on an outer circumferential portion of the cooling jacket 32. The cooling medium is allowed to flow in advance through the cooling jacket 32. Accordingly, the heat of a first branched air flow is sufficiently conducted to the cooling medium as the first branched air flow flows along the first hollow tube portion 210 through the third hollow tube portion 214. Consequently, the first branched air flow becomes relatively low in temperature. More specifically, according to the present embodiment, in accordance with the cooling jacket 32 that serves in order to cool the rotating electric machine 16, the temperature of the first branched air flow can be lowered.

The first branched air flow that has flowed through the first hollow tube portion 210 to the third hollow tube portion 214 flows into three individual starting passages 160 via the flexible tubes 218, 220, and 222. The first branched air flow air further flows through the starting passages 160, and flows into the rotor chamber 28 that is formed diametrically inward of the partition wall member 26.

Thereafter, one portion of the first branched air flow flows toward the first insertion hole 96 via the first air branching passage L inside the rotor chamber 28. Further, a remaining portion of the first branched air flow flows via the second air branching passage M inside the rotor chamber 28, passes along the clearance between the outer walls of the permanent magnets 88 and the inner circumferential wall of the partition wall member 26, and flows toward the second insertion hole 110. In this manner, the first branched air flow is divided into compressed air that flows toward the first insertion hole 96 at the left end (the first end), and compressed air that flows toward the second insertion hole 110 at the right end (the second end).

The one portion of the first branched air flow flows through the clearance between the outer walls of the permanent magnets 88 and the inner circumferential wall of the partition wall member 26, and thereby cools the rotor 50. In the rotor chamber 28, the direction in which the first branched air flow flows is the first direction from the first end toward the second end. In this instance, as noted previously, the first branched air flow is sufficiently reduced in temperature by the cooling jacket 32. Accordingly, the rotor 50 is efficiently cooled.

Further, according to the present embodiment, the rotating electric machine 16 is cooled using the compressed air that is generated by the gas turbine engine 14. Accordingly, it is not necessary to supply the cooling air to the rotor chamber 28 in order to cool the rotor 50. Consequently, while cooling of the rotor 50 is achieved, it is possible to simplify the configuration of the combined power system 12.

The one portion of the first branched air flow that has flowed toward the first insertion hole 96 reaches the first proximal end 102 of the first insertion hole 96. In the first proximal end 102, the one portion of the first branched air flow becomes an air curtain for the first bearing 84. On the other hand, a remaining portion of the first branched air flow that has flowed toward the second insertion hole 110 reaches the second distal end 112 of the second insertion hole 110. In the second distal end 112, the remaining portion of the first branched air flow becomes an air curtain for the second bearing 104.

An excessive amount of the first branched air flow is recovered in the gas-liquid separation device 245 (the oil circulation supply device) via the exhaust passage 233.

A description will now be given concerning the route of the second branched air flow. The second downstream communication holes 242, 244, and 246 individually overlap with the three individual inlet ports 130 that are formed in the base portion 124 of the rectifying member 122. Accordingly, the second branched air flow flows into the relay chamber 132 (the hollow interior of the rectifying member 122) through the inlet ports 130.

As noted previously, the outlet of the relay chamber 132 opens at a position that faces toward the small diameter cylindrical portion 136 of the compressor wheel 78. Accordingly, the second branched air flow that has flowed into the relay chamber 132 comes into contact with the small diameter cylindrical portion 136. The one portion of the second branched air flow reaches the second proximal end 114 of the second insertion hole 110. In the second proximal end 114, the one portion of the second branched air flow becomes an air curtain for the second bearing 104. In this manner, the second bearing 104 is sandwiched between the remaining portion of the second branched air flow that has reached the second proximal end 114, and the one portion of the first branched air flow that has reached the second distal end 112.

The remaining portion of the second branched air flow is discharged into the interior of the left end of the shroud case 231. At the left end opening of the shroud case 231, the air is drawn in as noted previously. Accordingly, the remaining portion of the second branched air flow is compressed by the compressor wheel 78 along with the drawn-in atmospheric air.

As noted previously, due to the chamber provided between the inner housing 314 and the shroud case 231, the pressure of the curtain air is equalized. Accordingly, the occurrence of a pressure distribution in the curtain air is avoided. Further, the occurrence of surging in the curtain air is also avoided. Therefore, while the pressure of the curtain air is maintained substantially constant, it is possible to supply the curtain air circumferentially around the first bearing 84 and the second bearing 104.

Next, a description will be given concerning the lubricating oil passage. One portion of the lubricating oil is supplied as a lubricating agent to the first bearing 84 and the second bearing 104. A remaining portion of the lubricating oil is supplied to the rotating shaft 54 and the stator 52 as cooling oil for cooling the rotating electric machine 16. Next, herein, a description will be given concerning the route by which the lubricating oil is supplied to the stator 52.

The lubricating oil, which is drawn out from the tank 251, reaches the input tube portion 247 from the oil supply line 250. Since the input tube portion 247 is formed in proximity to the second end in the outer circumferential wall of the main housing 20, the cooling oil flows into the second end side of the stator chamber 30. Due to the discharged force of the circulation pump 253, the cooling oil flows through from the second end toward the first end of the stator chamber 30. More specifically, in the stator chamber 30, the direction in which the second cooling oil flows is the second direction from the second end toward the first end.

In the stator chamber 30, which is the housing internal oil passage, the cooling oil, for example, flows through the stator inner circumferential side oil passage 170. Further, the cooling oil flows through gaps between the electromagnetic coils 150 in the stator 52. Further, the cooling oil flows through the inner hole of the stator 52 (the gaps between the stator core 140). In this manner, by the cooling oil coming into contact with the stator 52, the stator 52 is efficiently cooled.

The cooling oil passes through the coolant passage 278 that is provided in the neutral point fixing structure 144. By the cooling oil passing through the coolant passage 278, the neutral point 272 and the neutral point terminal 274 are cooled. Further, the conduction of heat from the coil end portion 154 to the neutral point terminal 274 can be reduced.

The cooling oil that has flowed through the stator chamber 30 (the housing internal oil passage) flows from the first end of the stator chamber 30 into the contact chamber 38 of the first casing 34. The cooling oil inside the contact chamber 38 comes into contact with the terminal portions 198, the terminal wires 200, and the screws 202. Consequently, the electrical contact between the U-phase terminal 190 and the U-phase coils is cooled. For the same reason, the electrical contact between the V-phase terminal 192 and the V-phase coils is also cooled. The electrical contact between the W-phase terminal 194 and the W-phase coils is also cooled.

The cooling oil inside the contact chamber 38 flows into the oil recovery line 252 via the output tube portion 248. The lubricating oil that has flowed through the oil recovery line 252 is recovered in the gas-liquid separation device 245.

The gas-liquid separation device 245 recovers the curtain air and the cooling oil. Inside the rotating electric machine housing 18, the cooling oil is blocked by the air curtain. Therefore, the lubricating oil is contained in the curtain air that is exhausted from the exhaust passage 233. More specifically, the curtain air exhausted from the exhaust passage 233 is substantially a gas-liquid mixture.

In the gas-liquid separation device 245, the gas-liquid mixture is separated into air and the lubricating oil. The air passes through the exhaust line 254 that is provided in the gas-liquid separation device 245, and is released to the atmosphere. The lubricating oil is temporarily stored in the tank 251. The lubricating oil inside the tank 251 is drawn out from the gas-liquid separation device 245 by the circulation pump 253. Furthermore, in accordance with the foregoing, the lubricating oil is supplied again from the gas-liquid separation device 245.

Moreover, although not illustrated, one portion of the lubricating oil is drawn out from the tank 251 into the oil supply line 250 by the circulation pump 253. The one portion of the lubricating oil is supplied to the first bearing 84 and the second bearing 104. Consequently, the first bearing 84 and the second bearing 104 are sufficiently lubricated.

In the foregoing manner, the first branched air flow becomes the air curtain for the first bearing 84. The second branched air flow becomes the air curtain for the second bearing 104. Therefore, a situation is avoided in which the lubricating oil that lubricates the first bearing 84 and the second bearing 104 enters between the rotating shaft 54 and the electromagnetic coils 150. Further, a situation is avoided in which the lubricating oil infiltrates into the relay chamber 132 of the rectifying member 122. Consequently, it is possible to avoid a situation in which the permanent magnets 88 and the rectifying member 122 become contaminated by the lubricating oil.

The present embodiment possesses the following advantageous effects.

As shown in FIG. 8, the neutral point terminal 274 is fixed to the coil end portion 154 via the insulating member 276. Consequently, the coil end portion 154, which becomes of a high temperature at a time when the rotating electric machine 16 is operating, and the neutral point terminal 274 can be thermally separated. As a result, it is possible to prevent both the electromagnetic coils 150 and the neutral point terminal 274 from becoming high in temperature.

Further, the liquid coolant passes through the coolant passage 278 provided between the neutral point terminal 274 and the insulating member 276. Consequently, the neutral point terminal 274 can be cooled by the liquid coolant. Further, the conduction of heat from the coil end portion 154 to the neutral point terminal 274 can be reduced. As a result, a rise in temperature at the neutral point terminal 274 can be suppressed.

Therefore, according to the present embodiment, it is possible to suppress a decrease in efficiency and deterioration of the rotating electric machine 16 due to the generation of heat by the rotating electric machine 16.

Further, the pedestal 294, which serves as the insulating member 276, is arranged on the coil end portion 154. Further, the neutral point terminal 274 is arranged on the pedestal 294. Consequently, the neutral point terminal 274 can be easily fixed to the coil end portion 154. Further, the neutral point terminal 274 and the coil end portion 154 can be easily separated from each other.

As shown in FIG. 6 and FIG. 8, the neutral point terminal 274 can be easily arranged on the first surface 296 of the pedestal 294. Further, the second surface 298 of the pedestal 294 can be easily arranged on the coil end portion 154. Furthermore, the coolant passage 278 extends in parallel with the first surface 296 and the second surface 298. Consequently, the conduction of heat from the coil end portion 154 to the neutral point terminal 274 can be efficiently reduced.

As shown in FIG. 6 to FIG. 8, the coolant passage 278 is constituted by the first concave portions 300 that are formed in the first surface 296 of the pedestal 294. Consequently, the coolant passage 278 can be provided within a limited space.

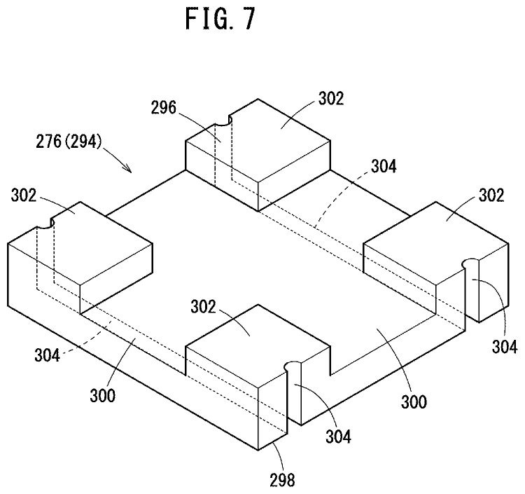

As shown in FIG. 7, the two first concave portions 300 are formed along the first surface 296, and together therewith, intersect one another. In accordance with this feature, as shown in FIG. 6, two of the coolant passages 278 can be provided within a limited space. Further, by providing the two coolant passages 278, a greater amount of the coolant can be allowed to pass therethrough. Consequently, the neutral point terminal 274 can be efficiently cooled. Further, the conduction of heat from the coil end portion 154 shown in FIG. 8 to the neutral point terminal 274 can be efficiently reduced.

As shown in FIG. 6 and FIG. 8, the neutral point terminal 274 is the tubular shaped member 290. Consequently, the terminal ends 270 of the plurality of conductive wires 152 can be easily inserted into the inner side space 292 of the tubular shaped member 290. Furthermore, the terminal ends 270 of the plurality of conductive wires 152 that have been inserted can be connected, and thereby be constituted as the neutral point 272.

Further, the portion within the tubular shaped member 290 that faces toward the first concave portions 300 is recessed toward an inner side of the tubular shaped member 290. In accordance with this feature, the second concave portion 308 is formed. Further, the coolant passage 278 is constituted by placing the first concave portions 300 and the second concave portion 308 in facing relation to each other. Consequently, it is possible for the coolant passage 278 to be easily configured within a limited space. Furthermore, the cross-sectional area of the coolant passage 278 is made larger, thereby allowing a greater amount of the liquid coolant to pass therethrough. As a result, the neutral point terminal 274 can be cooled more efficiently. Further, the conduction of heat from the coil end portion 154 to the neutral point terminal 274 can be reduced more efficiently.

Furthermore, the portion within the tubular shaped member 290 that faces toward the first concave portions 300 is recessed toward the inner side of the tubular shaped member 290. Consequently, the terminal ends 270 of the plurality of conductive wires 152 that are inserted into the inner side space 292 of the tubular shaped member 290 can be easily caulked or crimped. As a result, the electrical connection between the terminal ends 270 of the plurality of conductive wires 152 can be reliably established. Further, it is possible to prevent the terminal ends 270 of the plurality of conductive wires 152 from coming off from the tubular shaped member 290.

The first threaded member 280 is wound around the pedestal 294 and the neutral point terminal 274. Consequently, the neutral point terminal 274 can be fixed to the pedestal 294.

The first threaded member 280 is locked in the locking grooves 304 that are formed on the surface of the pedestal 294. Consequently, the neutral point terminal 274 can be reliably fixed to the pedestal 294.

The second threaded member 282 is wound around the coil end portion 154 and the pedestal 294. Consequently, the pedestal 294 can be fixed to the coil end portion 154.

As shown in FIG. 5, using the oil circulation supply device, the cooling oil is supplied to the stator chamber 30 via the oil supply line 250. In accordance with this feature, the stator 52 can be sufficiently cooled by the cooling oil. In accordance with this feature, in the rotating electric machine 16, a decrease in the conversion efficiency between the mechanical energy and the electrical energy is suppressed. Consequently, the rotating electric machine 16 maintains a predetermined output.

As shown in FIG. 2 to FIG. 4, the interior of the rotating electric machine housing 18 is partitioned by the partition wall member 26 into the rotor chamber 28 and the stator chamber 30. In accordance with this feature, it is possible to prevent the cooling oil from entering into the rotor chamber 28. As a result, in particular, the permanent magnets 88 are prevented from becoming contaminated by the lubricating oil.

Moreover, according to the present embodiment, the neutral point fixing structure 144 may be configured as shown in the exemplary modification shown in FIG. 9. In FIG. 9, an insulating coating 330 that covers the plurality of conductive wires 152 serves as the insulating member 276. More specifically, in the coil end portion 154, the plurality of conducting wires 152 are guided around in a circumferential direction of the stator 52. Therefore, in the coil end portion 154, the insulating coating 330 of the plurality of conductive wires 152 is disposed on an outer end portion along the axial direction of the stator 52. According to the present exemplary modification, the neutral point terminal 274 is fixed to the coil end portion 154 via the insulating coating 330 which serves as the insulating member 276. Even in this case, the above-described advantageous effects can be obtained.

Further, the plurality of electromagnetic coils 150 are covered with a non-illustrated insulating paper. Therefore, such an insulating paper may be arranged between the coil end portion 154 and the neutral point terminal 274, and the neutral point terminal 274 may be fixed to the coil end portion 154 via the insulating paper.

According to the present embodiment, a case has been described in which two of the first concave portions 300 are formed in the first surface 296. In the present embodiment, a single first concave portion 300 may be formed in the first surface 296. Even in this case, the coolant passage 278 that includes the single first concave portion 300 can be constituted.

Further, according to the present embodiment, a case has been described in which the coolant passage 278 is constituted by the first concave portions 300 and the second concave portion 308. According to the present embodiment, it is also possible for the coolant passage 278 to be constituted by only one of those from among the first concave portions 300 and the second concave portion 308.

Further, according to the present embodiment, the neutral point terminal 274 may be fixed with respect to the insulating member 276 (the pedestal 294) without using the first threaded member 280. For example, the neutral point terminal 274 may be fixed to the insulating member 276 (the pedestal 294) by an adhesive or the like. In this case, the locking grooves 304 need not necessarily be provided.

Further, according to the present embodiment, the insulating member 276 (the pedestal 294) may be fixed to the coil end portion 154 without using the second threaded member 282. For example, the insulating member 276 (the pedestal 294) may be fixed to the coil end portion 154 by an adhesive or the like.

In relation to the above-described disclosure, the following Supplementary Notes are further disclosed.

### Supplementary Note 1

The present invention is characterized by the rotating electric machine system (10) equipped with the rotating electric machine (16) including the rotor (50) and the stator (52), and the housing (18) in which the rotating electric machine is accommodated, wherein the housing accommodates the stator, and further includes the stator chamber (30) through which the liquid coolant configured to cool the stator flows, and the stator includes the stator core (140), the coil unit (142) including the plurality of coils (150) formed by the plurality of wires (152) that are wound around the stator core, and the coil end portion (154) serving as end parts of the plurality of coils, and the neutral point fixing structure (144) configured to fix to the coil end portion the neutral point (272) formed by bundling together and connecting the terminal ends (270) of the plurality of conductive wires that are pulled out from the coil unit, wherein the neutral point fixing structure includes the neutral point terminal (274) disposed at the neutral point, the insulating member (276) disposed between the neutral point terminal and the coil end portion, and the coolant passage (278) in order to allow the liquid coolant to pass between the neutral point terminal and the insulating member, and wherein the neutral point terminal is fixed to the coil end portion via the insulating member.

In accordance with such a configuration, the neutral point terminal is fixed to the coil end portion via the insulating member. Consequently, the coil end portion, which becomes of a high temperature at a time when the rotating electric machine is operating, and the neutral point terminal can be thermally separated. As a result, it is possible to prevent both the coils and the neutral point terminal from becoming high in temperature.

Further, the liquid coolant passes through the coolant passage provided between the neutral point terminal and the insulating member. Consequently, the neutral point terminal can be cooled by the liquid coolant. Further, the conduction of heat from the coil end portion to the neutral point terminal can be reduced. As a result, a rise in temperature at the neutral point terminal can be suppressed.

Therefore, according to the present invention, it is possible to suppress a decrease in efficiency and deterioration of the rotating electric machine due to the generation of heat by the rotating electric machine.

### Supplementary Note 2

In the rotating electric machine system according to Supplementary Note 1, the insulating member may be the pedestal (294) disposed at the coil end portion and on which the neutral point terminal is disposed.

In accordance with such a configuration, the pedestal, which serves as the insulating member, is arranged on the coil end portion. Further, the neutral point terminal is arranged on the pedestal. Consequently, the neutral point terminal can be easily fixed to the coil end portion. Further, the neutral point terminal and the coil end portion can be easily separated from each other.

### Supplementary Note 3

In the rotating electric machine system according to Supplementary Note 2, the pedestal may include the first surface (296) and the second surface (298) that are surfaces on opposite sides from each other, the neutral point terminal may be arranged on the first surface, the second surface may abut against the coil end portion, and the coolant passage may extend in parallel with the first surface and the second surface.

In accordance with such a configuration, the neutral point terminal can be easily arranged on the first surface of the pedestal. Further, the second surface of the pedestal can be easily arranged on the coil end portion. Furthermore, the coolant passage extends in parallel with the first surface and the second surface. Consequently, the conduction of heat from the coil end portion to the neutral point terminal can be efficiently reduced.

### Supplementary Note 4

In the rotating electric machine system according to Supplementary Note 3, the first concave portion (300) may be formed along the first surface on the first surface of the pedestal, and the first concave portion may constitute the coolant passage.

In accordance with such a configuration, the coolant passage is constituted by the first concave portion that is formed in the first surface of the pedestal. Consequently, the coolant passage can be provided within a limited space.

### Supplementary Note 5

In the rotating electric machine system according to Supplementary Note 4, two of the first concave portions may be formed along the first surface on the first surface of the pedestal, and the two first concave portions may intersect one another.

In accordance with such a configuration, the two first concave portions are formed along the first surface, and together therewith, intersect one another. Consequently, two of the coolant passages can be provided within a limited space. Further, by providing the two coolant passages, a greater amount of the coolant can be allowed to pass therethrough. Consequently, the neutral point terminal can be efficiently cooled. Further, the conduction of heat from the coil end portion to the neutral point terminal can be efficiently reduced.

### Supplementary Note 6

In the rotating electric machine system according to Supplementary Note 4, the neutral point terminal may be the tubular shaped member (290) the outer circumferential surface of which abuts against the first surface of the pedestal, terminal ends of the plurality of conductive wires that are pulled out from the coil unit may be inserted into the inner side space (292) of the tubular shaped member, within the tubular shaped member, the second concave portion (308) may be formed by recessing a portion that faces toward the first concave portion toward an inner side of the tubular shaped member, and the coolant passage may be constituted by the first concave portion and the second concave portion.

In accordance with such a configuration, the neutral point terminal is a tubular shaped member. Consequently, the terminal ends of the plurality of conductive wires can be easily inserted into the inner space of the tubular shaped member. Furthermore, the terminal ends of the plurality of conductive wires that have been inserted can be connected, and thereby be constituted as the neutral point.

Further, a portion within the tubular shaped member that faces toward the first concave portion is recessed toward an inner side of the tubular shaped member. In accordance with this feature, the second concave portion is formed. Further, the coolant passage is constituted by placing the first concave portion and the second concave portion in facing relation to each other. Consequently, it is possible for the coolant passage to be easily configured within a limited space. Furthermore, the cross-sectional area of the coolant passage is made larger, thereby allowing a greater amount of the liquid coolant to pass therethrough. As a result, the neutral point terminal can be cooled more efficiently. Further, the conduction of heat from the coil end portion to the neutral point terminal can be reduced more efficiently.

Furthermore, the portion within the tubular shaped member that faces toward the first concave portion is recessed toward the inner side of the tubular shaped member. Consequently, the terminal ends of the plurality of conductive wires that are inserted into the inner space of the tubular shaped member can be easily caulked or crimped. As a result, an electrical connection between the terminal ends of the plurality of conductive wires can be reliably established. Further, it is possible to prevent the terminal ends of the plurality of conductive wires from coming off from the tubular shaped member.

### Supplementary Note 7

In the rotating electric machine system according to any one of Supplementary Notes 2 to 6, the neutral point fixing structure may further include the first threaded member (280) wound around the pedestal, and the neutral point terminal that is arranged on the pedestal.

In accordance with such a configuration, the first threaded member is wound around the pedestal and the neutral point terminal. Consequently, the neutral point terminal can be fixed to the pedestal.

### Supplementary Note 8

In the rotating electric machine system according to Supplementary Note 7, the locking groove (304) configured to cause the first threaded member to be locked may be formed on a portion within the surface of the pedestal that does not come into contact with the neutral point terminal.

In accordance with such a configuration, the first threaded member is locked in the locking groove that is formed on the surface of the pedestal. Consequently, the neutral point terminal can be reliably fixed to the pedestal.

### Supplementary Note 9

In the rotating electric machine system according to any one of Supplementary Notes 2 to 6, the neutral point fixing structure may further include the second threaded member (282) wound around the coil end portion and the pedestal that is disposed on the coil end portion.

In accordance with such a configuration, the second threaded member is wound around the coil end portion and the pedestal. Consequently, the pedestal can be fixed to the coil end portion.

### Supplementary Note 10

In the rotating electric machine system according to any one of Supplementary Notes 1 to 9, the rotor may include the rotating shaft (54), and the permanent magnets (88) disposed on the rotating shaft, the rotating electric machine system may further include the oil circulation supply device (245) configured to circulate and supply the cooling oil, which is the liquid coolant, to the stator chamber, and the oil circulation supply device may further include the oil supply line (250) configured to supply the cooling oil to the stator chamber, and the oil recovery line (252) configured to recover the cooling oil that has flowed through the stator chamber.

In accordance with such a configuration, using the oil circulation supply device, the cooling oil is supplied to the stator chamber via the oil supply line. In accordance with this feature, the stator can be sufficiently cooled by the cooling oil. As a result, in the rotating electric machine, a decrease in the conversion efficiency between the mechanical energy and the electrical energy is suppressed. Consequently, a predetermined output of the rotating electric machine can be maintained.

### Supplementary Note 11

In the rotating electric machine system according to Supplementary Note 10, there may further be provided the cylindrically shaped partition wall member (26) interposed between the rotor and the stator in the diametrical direction of the rotating shaft, wherein the partition wall member partitions the interior of the housing into the stator chamber, and the rotor chamber (28) in which the rotor is accommodated.

In accordance with such a configuration, the interior of the rotating electric machine housing is partitioned by the partition wall member into the rotor chamber and the stator chamber. In accordance with this feature, it is possible to prevent the cooling oil from entering into the rotor chamber. As a result, in particular, the permanent magnets are prevented from becoming contaminated by the cooling oil.

Moreover, it should be noted that the present invention is not limited to the disclosure described above, but various configurations may be adopted therein without departing from the essence and gist of the present invention.

1. A rotating electric machine system equipped with a rotating electric machine including a rotor and a stator, and a housing in which the rotating electric machine is accommodated,
wherein the housing accommodates the stator, and further includes a stator chamber through which a liquid coolant configured to cool the stator flows, and
the stator comprises:
a stator core;
a coil unit including a plurality of coils formed by a plurality of wires that are wound around the stator core, and a coil end portion serving as end parts of the plurality of coils; and
a neutral point fixing structure configured to fix to the coil end portion a neutral point formed by bundling together and connecting terminal ends of the plurality of conductive wires that are pulled out from the coil unit,
wherein the neutral point fixing structure comprises:
a neutral point terminal disposed at the neutral point;
an insulating member disposed between the neutral point terminal and the coil end portion; and
a coolant passage in order to allow the liquid coolant to pass between the neutral point terminal and the insulating member, and
wherein the neutral point terminal is fixed to the coil end portion via the insulating member.

2. The rotating electric machine system according to claim 1, wherein the insulating member is a pedestal disposed at the coil end portion and on which the neutral point terminal is disposed.

3. The rotating electric machine system according to claim 2, wherein the pedestal includes a first surface and a second surface that are surfaces on opposite sides from each other,
the neutral point terminal is arranged on the first surface,
the second surface abuts against the coil end portion, and
the coolant passage extends in parallel with the first surface and the second surface.

4. The rotating electric machine system according to claim 3, wherein a first concave portion is formed along the first surface on the first surface of the pedestal, and
the first concave portion constitutes the coolant passage.

5. The rotating electric machine system according to claim 4, wherein two of the first concave portions are formed along the first surface on the first surface of the pedestal, and
the two first concave portions intersect one another.

6. The rotating electric machine system according to claim 4, wherein the neutral point terminal is a tubular shaped member an outer circumferential surface of which abuts against the first surface of the pedestal,
the terminal ends of the plurality of conductive wires that are pulled out from the coil unit are inserted into an inner side space of the tubular shaped member,
within the tubular shaped member, a second concave portion is formed by recessing a portion that faces toward the first concave portion toward an inner side of the tubular shaped member, and
the coolant passage is constituted by the first concave portion and the second concave portion.

7. The rotating electric machine system according to claim 2, wherein the neutral point fixing structure further comprises a first threaded member wound around the pedestal and the neutral point terminal that is arranged on the pedestal.

8. The rotating electric machine system according to claim 7, wherein a locking groove configured to cause the first threaded member to be locked is formed on a portion within a surface of the pedestal that does not come into contact with the neutral point terminal.

9. The rotating electric machine system according to claim 2, wherein the neutral point fixing structure further comprises a second threaded member wound around the coil end portion and the pedestal that is disposed on the coil end portion.

10. The rotating electric machine system according to claim 1, wherein the rotor includes a rotating shaft, and permanent magnets disposed on the rotating shaft,
the rotating electric machine system further comprises an oil circulation supply device configured to circulate and supply a cooling oil, which is the liquid coolant, to the stator chamber, and
the oil circulation supply device includes an oil supply line configured to supply the cooling oil to the stator chamber, and an oil recovery line configured to recover the cooling oil that has flowed through the stator chamber.

11. The rotating electric machine system according to claim 10, further comprising a cylindrically shaped partition wall member interposed between the rotor and the stator in a diametrical direction of the rotating shaft,
wherein the partition wall member partitions the interior of the housing into the stator chamber, and a rotor chamber in which the rotor is accommodated.
